(19) United States
(12) Patent Application Publication
(10) Pub. No.: US 2013/0037049 A1
(43) Pub. Date: Feb. 14, 2013

(54) Hygienic article

(71) Applicant: Vyacheslav Leonidovich Kulichkov, Kolomna (RU)

(72) Inventor: Vyacheslav Leonidovich Kulichkov, Kolomna (RU)

(21) Appl. No.: 13/254,545

(22) PCT Filed: Jun. 1, 2010
(86) PCT No.: PCT/RU2010/000284

§ 371 Date: Aug. 30, 2012

(30) Foreign Application Priority Data
Apr. 29, 2010 (RU) 2010116855

(51) Int. Cl. B08B 1/00

(52) U.S. Cl. 134/6; 15/231; 15/104.93

(57) ABSTRACT

The technical decision is applied for cleaning exteriority of external male genital organs. The hygienic article consists of the handle made to the shape of a dowel with the possibility of grasping by thumb and index finger of human hand and the sheaf of sliced cleaning material. The handle is made from press paper; sanitary-hygienic paper is used as the sliced cleaning material.

The technical decision relates to sanitary-hygienic products for personal use.

There are known products applied for cleaning exteriority of external male genital organs, namely balanus. The closest technical solution taken as a prototype is described in International Application No. WO 02/17746, published on Mar. 7, 2002.

The subject hygienic article consists of the handle made to the shape of a dowel with the possibility of grasping by thumb and index finger of human hand (the handle is made from plastic and similar products) and the sheaf, namely sliced cleaning material—hair of fur animals (sable, squirrel and others). The subject hygienic article provides primarily attacking medical problems and is not designed for use as hygienic article of daily application. Proposed technical solution delocalizes the field of application of hygienic articles for cleaning exteriority of external male genital organs and takes a possibility to use the hygienic article for cleaning balanus after urination.

The technical result obtained while use of the hygienic article of the proposed design would be in excluding of traumatism while use thereof, securing product environmental criteria by using the materials for manufacturing the hygienic article that are not harmful to the environment and in possibility of no recoverable use of the article.

The above technical result is achieved by the fact that according to the technical decision the handle of the subject hygienic article consisting of the handle made to the shape of a dowel with the possibility of grasping by thumb and index finger of human hand is made from press paper and that sanitary-hygienic paper is used as the sliced cleaning material.

For the preferable variant of manufacturing of the hygienic article the handle, as well as the sheaf of sliced cleaning material are made from sanitary-hygienic paper. The lengths of the sheaf of sliced cleaning material can be more or the same as the lengths of the handle, or it can be less or the same as the lengths of the handle. The handle can be additionally glued. The sheaf of sliced sanitary-hygienic paper can be impregnated with flavoring and/or disinfectant.

The hygienic article is like a small brash that is accessible for grasping by human thumb and index finger. Consequently, the size of the hygienic product is comparable with the size of maniphanx of a human hand. The handle of the hygienic product is made to the shape of a small dowel. On the end point of the handle there is a sheaf of sliced cleaning material (analogue of bristle brush). All component parts of the hygienic article as well as the handle and the sheaf of sliced cleaning material are made from the same material namely, from paper, in the majority of cases for the manufacturing of the whole hygienic article it should be used sanitary-hygienic paper (also known under the trade names “paper-foundation of sanitary hygienic products”, “sanitary-hygienic foundation”), namely the paper applied for manufacturing of soft tissue paper, napkins and similar products exhibiting hydroscopic properties and being decomposable due to the influence of aquatic medium. For manufacturing the handle it is possible to use paper other than sanitary hygienic paper, fur manufacturing the handle the paper is extruded and can be additionally glued. The part of the hygienic article consisting of sliced cleaning material can be more, less or the same as lengths of the handle. Sliced cleaning material—sanitary-hygienic paper can be impregnated with various flavorings and disinfectants.

After urination the subject hygienic article is used for cleaning balanus. The use of the article is allowed only on a single occasion, after use it should be put aside. With respect to the manufacturing the article from impermanent materials the article does not affect the environment and does not clog canalization system irrespectively to the place of utilization. The article can be sold through retail net or dispensers situated in public toilets.

Thus, there is offered the hygienic article being harmless and soft for the environment.

1-7. (canceled)

8. A method of cleaning a surface of a male external genitalia comprising
holding by thumb and index finger of man a sheaf of cleaning cut material,
rubbing a head of penis after urinating by said sheaf of cleaning cut material and
utilization of the sheaf of cleaning cut material after single use,
wherein said sheaf of cleaning cut material being made from a sanitary and hygienic paper.

9. A hygiene article comprising
a sheaf of a cut sliced cleaning material
and a handle, made in a form of a rod with the ability to capture by a thumb and index finger of man,
wherein the cut sliced cleaning material is shredded sanitary-hygienic paper, and the handle is made of pressed paper.

10. The hygienic article of claim 2 wherein the handle is made from sanitary hygienic paper.

11. The hygienic article of claim 2 wherein lengths of the sheaf of sliced cut cleaning material is more the lengths of the handle.

12. The hygienic article of claim 2 wherein lengths of the sheaf of sliced cleaning material is a same as the lengths of the handle.

13. The hygienic article of claim 2 wherein lengths of the sheaf of sliced cleaning material is less than the lengths of the handle.

14. The hygienic article of claim 2 wherein the handle is additionally glued.

15. The hygienic article of claim 2 wherein the sheaf of cut sliced paper is impregnated with flavoring.

16. The hygienic article of claim 2 wherein the sheaf of cut sliced paper is impregnated with disinfectant.
